(19) United States
(12) Patent Application Publication
(10) Pub. No.: US 2024/0138290 A1
(43) Pub. Date: May 2, 2024

(54) AUXILIARY STORAGE COMPARTMENT ASSEMBLY FOR AN AIR CART

(71) Applicant: CNH Industrial Canada, Ltd., Saskatoon (CA)

(72) Inventors: Jesse Blair Pidwerbesky, Warman (CA); Jackie Donald Turner, Saskatoon (CA); Robin Bruno Schilling, Darfield (CA)

(21) Appl. No.: 18/498,567

(22) Filed: Oct. 31, 2023

Related U.S. Application Data
(60) Provisional application No. 63/420,791, filed on Oct. 31, 2022.

(51) Int. Cl. A01C 15/00; A01C 15/04

(52) U.S. Cl. CPC A01C 15/006; A01C 15/04

(57) ABSTRACT

An auxiliary storage compartment assembly for an air cart includes an auxiliary storage compartment having an opening. The auxiliary storage compartment assembly also includes a filling assembly coupled to the auxiliary storage compartment. The filling assembly includes a fill chute engaged with the auxiliary storage compartment, an outlet of the filling assembly is aligned with the opening, and the filling assembly establishes a flow path that extends downwardly and laterally inwardly from an inlet to the outlet. In addition, the auxiliary storage compartment assembly includes a conveyor assembly having a rotary conveyor. The rotary conveyor extends through a portion of the filling assembly and through a portion of the auxiliary storage compartment, and the rotary conveyor is configured to move particulate material laterally through the portion of the filling assembly and through the portion of the auxiliary storage compartment in response to rotation of the rotary conveyor.

### CROSS-REFERENCE TO RELATED APPLICATION

This application claims priority from and the benefit of U.S. Provisional Application Ser. No. 63/420,791, entitled “AUXILIARY STORAGE COMPARTMENT ASSEMBLY FOR AN AIR CART”, filed Oct. 31, 2022, which is hereby incorporated by reference in its entirety.

### BACKGROUND

The present disclosure relates generally to an auxiliary storage compartment assembly for an air cart.

Generally, agricultural implements are towed behind a work vehicle, such as a tractor. The agricultural implement may include multiple rows of ground engaging opener assemblies to excavate trenches into soil for depositing a particulate material, such as seeds or fertilizer. An air cart may be towed behind or in front of the agricultural implement and configured to provide the particulate material to the ground engaging opener assemblies. In this manner, rows of the particulate material may be deposited into the soil. Some particulate material (e.g., wheat seeds, fertilizer, etc.) may be deposited into the soil in large quantities. Accordingly, the particulate material may be stored in a larger primary storage compartment. Further, some particulate material (e.g., canola seed, inoculants, etc.) may be deposited into the soil in small quantities. Accordingly, such particulate material may be stored in a smaller auxiliary storage compartment of the air cart.

Each primary storage compartment may include a tapered portion configured to direct the particulate material to a respective metering system. Each metering system, in turn, controls flow of the particulate material to the ground engaging opener assemblies of the agricultural implement. The auxiliary storage compartment may be positioned within a space between the tapered portions of adjacent primary storage compartments to efficiently utilize the available space within the air cart. However, positioning the auxiliary storage compartment between the tapered portions of adjacent primary storage compartments blocks access to the top of the auxiliary storage compartment. Accordingly, the auxiliary storage compartment may not be loaded from the top. Moreover, loading the auxiliary storage compartment from the side may cause the particulate material to be unevenly distributed within the auxiliary storage compartment. As a result, portions of a metering system positioned below the auxiliary storage compartment may not receive the particulate material, thereby causing the particulate material to be unevenly distributed throughout the field.

### BRIEF DESCRIPTION

In certain embodiments, an auxiliary storage compartment assembly for an air cart includes an auxiliary storage compartment configured to be positioned beneath a portion of a primary storage compartment of the air cart. The auxiliary storage compartment includes an opening in a lateral side of the auxiliary storage compartment. The auxiliary storage compartment assembly also includes a filling assembly coupled to the auxiliary storage compartment. The filling assembly includes a fill chute engaged with the lateral side of the auxiliary storage compartment, the filling assembly has an inlet and an outlet, the outlet is formed at the fill chute, the outlet is aligned with the opening of the auxiliary storage compartment, and the filling assembly establishes a flow path that extends downwardly and laterally inwardly from the inlet to the outlet. In addition, the auxiliary storage compartment assembly includes a conveyor assembly having a rotary conveyor and a motor assembly. The rotary conveyor extends through a portion of the filling assembly and through a portion of the auxiliary storage compartment, the motor assembly is configured to drive the rotary conveyor in rotation, and the rotary conveyor is configured to move particulate material laterally through the portion of the filling assembly and through the portion of the auxiliary storage compartment in response to rotation of the rotary conveyor. Furthermore, the motor assembly is coupled to the fill chute, and/or the motor assembly is disposed within the auxiliary storage compartment.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural system having an agricultural implement and an air cart;

FIG. 2 is a perspective view of an embodiment of an auxiliary storage compartment assembly and an embodiment of a metering system that may be employed within the air cart of FIG. 1;

FIG. 3 is a top perspective view of a portion of the auxiliary storage compartment assembly of FIG. 2;

FIG. 4 is a bottom perspective view of a portion of the auxiliary storage compartment assembly of FIG. 2;

FIG. 5 is a cross-sectional view of a portion of the auxiliary storage compartment assembly of FIG. 2;

FIG. 6 is a perspective view of a portion of the auxiliary storage compartment assembly of FIG. 2, in which a filling assembly of the auxiliary storage compartment assembly is in an operation state;

FIG. 7 is a perspective view of a portion of another embodiment of an auxiliary storage compartment assembly that may be employed within the air cart of FIG. 1; and

FIG. 8 is a perspective view of a portion of a further embodiment of an auxiliary storage compartment assembly that may be employed within the air cart of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

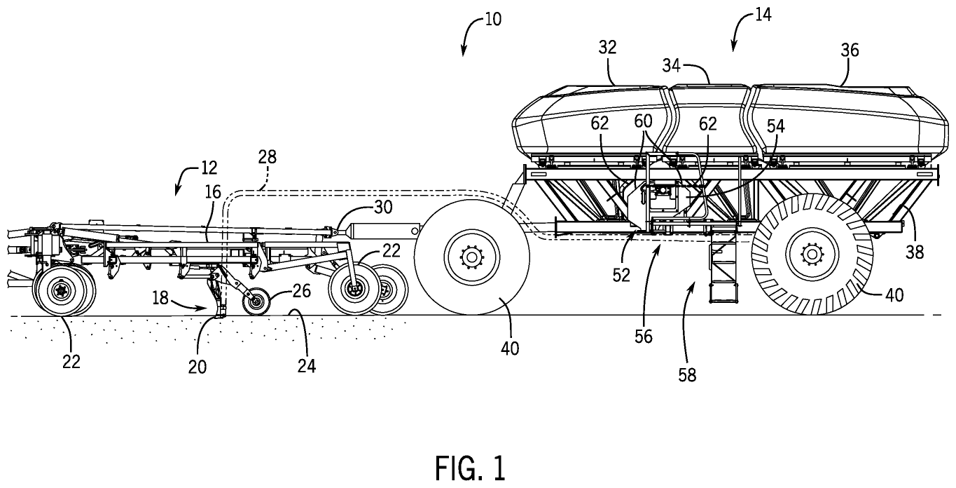

FIG. 1 is a side view of an embodiment of an agricultural system 10 having an agricultural implement 12 and an air cart 14. In the illustrated embodiment, the agricultural implement 12 includes a tool frame 16, and a row unit 18, which includes an opener 20, is coupled to the tool frame 16. As illustrated, wheel assemblies 22 are also coupled to the tool frame 16. The agricultural implement 12 may be pulled through a field by a work vehicle (e.g., a tractor), and the agricultural implement 12 may deposit rows of particulate material (e.g., seed, fertilizer, inoculant, etc.) into the soil as the agricultural implement 12 traverses the field. The wheel assemblies 22 contact the soil surface and enable the agricultural implement 12 to be pulled by the work vehicle, and the row unit 18 may deposit one row of the particulate material into the soil. Although only one row unit 18 is shown coupled to the tool frame 16 for clarity, the agricultural implement 12 may include multiple row units 18 (e.g., organized in one or more rows across the agricultural implement 12). In some embodiments, the agricultural implement 12 may include 12, 14, 16, 18, 20, or more row units 18, each of which may deposit particulate material into the soil to form a respective row.

To facilitate depositing the particulate material within the soil, each row unit 18 includes the opener 20. In response to movement of the row unit 18 through the field, the opener 20 exerts a force onto the soil 24, thereby excavating a trench within the soil 24. As the agricultural implement 12 moves through the field, the row unit 18 may deposit the particulate material into the excavated trench (e.g., via a seed tube). Then, a press wheel 26 of the row unit 18 may pack soil onto the deposited particulate material.

In the illustrated embodiment, the air cart 14 pneumatically distributes the particulate material to the row unit 18 via distribution hose(s) 28. The air cart 14 may include metering system(s) configured to control particulate material flow rate(s) to the distribution hose(s) 28, and an air source may provide an airflow through the distribution hose(s) 28. The airflow may interact with the particulate material flowing into each distribution hose 28 from a respective metering system, thereby fluidizing the particulate material and forming an air/particulate material mixture. Each distribution hose 28 is configured to transport the air/particulate material mixture to at least one row unit 18, thereby providing the row unit(s) with a metered flow of the particulate material. The air cart 14 may supply particulate material to multiple row units 18 (e.g., via one or more distribution hoses 28). As such, the metering system(s) of the air cart 14, each of which is coupled to one or more distribution hoses 28, may control the particulate material flow rate to multiple row units 18.

In the illustrated embodiment, the air cart 14 is towed behind the agricultural implement 12. For example, the agricultural implement 12 may be coupled to the work vehicle by a first hitch assembly, and the air cart 14 may be coupled to the agricultural implement 12 by a second hitch assembly 30. However, in other embodiments, the agricultural implement 12 may be towed behind the air cart 14. In further embodiments, the agricultural implement and the air cart may be part of a single unit that is towed behind a work vehicle, or the implement and the air cart may be elements of a self-propelled vehicle.

The air cart 14 may centrally store the particulate material (e.g., seeds) and distribute the particulate material (e.g., seeds) to the row units. In the illustrated embodiment, the air cart 14 includes three primary storage compartments 32, 34, and 36, a frame 38, and wheels 40. Further, the air cart 14 includes an auxiliary storage compartment assembly 52 having an auxiliary storage compartment 54. The towing hitch 30 couples the tool frame 16 of the agricultural implement 12 to the air cart frame 38, which enables the air cart 14 to be towed with the agricultural implement 12. In addition, the auxiliary storage compartment assembly 52 includes a filling assembly 56 coupled to the auxiliary storage compartment 54 and configured to direct particulate material into the auxiliary storage compartment. The auxiliary storage compartment assembly 52 also includes a platform assembly 58 positioned adjacent to the auxiliary storage compartment 54. The platform assembly 58 includes a platform configured to support an operator, thereby enabling the operator to load the particulate material into the filling assembly 56.

The primary storage compartments 32, 34, and 36, and the auxiliary storage compartment 54 may centrally store the particulate material (e.g., seeds, granular fertilizer, granular inoculant, etc.). In certain embodiments, the primary storage compartments 32, 34, and 36 may each store a different particulate material. For example, the first primary storage compartment 32 may store legume seeds, and the second primary storage compartment 34 may store a dry fertilizer. Additionally, in this example, the auxiliary storage compartment 54 may store granular inoculant, which is deposited into the soil in conjunction with the legume seeds and the dry fertilizer. The air cart 14 may deliver the seeds, fertilizer, and inoculant to the agricultural implement 12. A metering system is disposed below each storage compartment, and the metering system is configured to control the flow of the respective particulate material into respective distribution hose(s).

Further, as illustrated, the auxiliary storage compartment 54 is positioned beneath a portion of the first primary storage compartment 32 and a portion of the second primary storage compartment 34, and the auxiliary storage compartment 54 may include storage for more than 15 bushels (e.g., 529 liters) of particulate material. To improve storage capacity of the auxiliary storage compartment 54, upper walls 60 of the auxiliary storage compartment 54 have slopes that substantially correspond to respective slopes of bottom portions 62 of the first and second primary storage compartments 32 and 34. Therefore, the shape of the auxiliary storage compartment 54 enables the auxiliary storage compartment 54 to utilize a substantial portion of the space between the first and second primary storage compartments 32 and 34. In other embodiments, the auxiliary storage compartment may be positioned between the second and third primary storage compartments. Furthermore, in certain embodiments, the auxiliary storage compartment 54 may have another suitable shape.

As discussed in detail below, the auxiliary storage compartment 54 has an opening in a lateral side of the auxiliary storage compartment 54. The opening is configured to receive the particulate material from the filling assembly 56. In addition, the filling assembly 56 is coupled to the auxiliary storage compartment 54 (e.g., to the lateral side of the auxiliary storage compartment), and the filling assembly 56 has an inlet and an outlet. The outlet is aligned with the opening of the auxiliary storage compartment 54, and the filling assembly 56 establishes a flow path that extends downwardly and laterally inwardly (e.g., laterally toward the auxiliary storage compartment 54) from the inlet to the outlet. Furthermore, the auxiliary storage compartment assembly 52 includes a conveyor assembly having a rotary conveyor. The rotary conveyor extends through a portion of the filling assembly and through a portion of the auxiliary storage compartment 54. The rotary conveyor is configured to move the particulate material laterally through the portion of the filling assembly and through the portion of the auxiliary storage compartment in response to rotation of the rotary conveyor. Accordingly, the filling assembly 56 and the conveyor assembly cooperate to substantially evenly distribute the particulate material along a lateral axis within the auxiliary storage compartment. As a result, the respective metering system may receive a substantially uniform supply of the particulate material from the auxiliary storage compartment 54 during operation of the respective metering system.

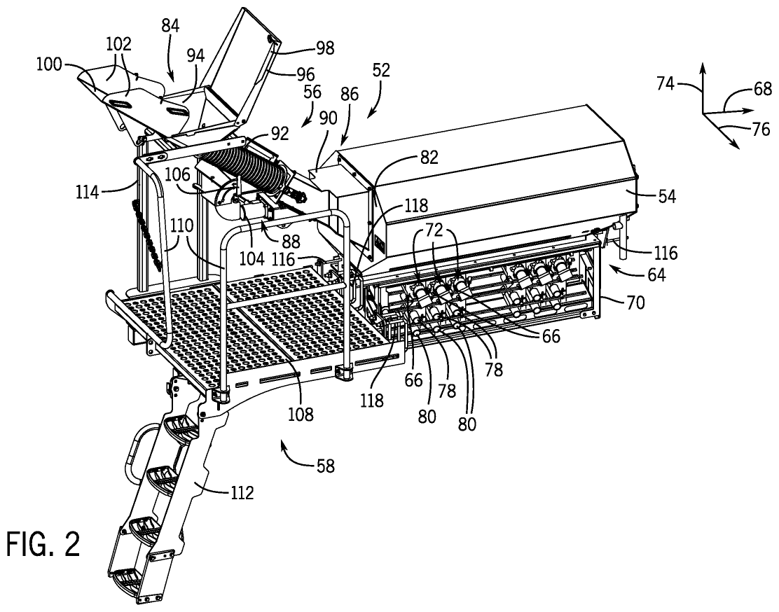

FIG. 2 is a perspective view of an embodiment of an auxiliary storage compartment assembly 52 and an embodiment of a metering system 64 that may be employed within the air cart of FIG. 1. The auxiliary storage compartment 54 is configured to store particulate material and to provide the particulate material to the metering system 64. In the illustrated embodiment, the metering system 64 includes multiple seed meters 66 distributed along a lateral axis 68 of the auxiliary storage compartment assembly 52, in which the seed meters 66 are supported by a frame 70. While the illustrated metering system 64 includes six seed meters 66, in other embodiments, the metering system may include 5, 6, 7, 8, 9, 10, 11, 12, or more seed meters. In the illustrated embodiment, each seed meter 66 includes at least one respective metering device 72 (e.g., meter roller) to control flow of particulate material to a respective conduit (e.g., distribution hose), which may provide the particulate material to a row unit or a header that distributes the particulate material to multiple row units. Each seed meter 66 also includes an inlet configured to receive the particulate material from the auxiliary storage compartment 54 (e.g., along a vertical axis 74).

Furthermore, each seed meter 66 includes a first conduit connector 78 and a second conduit connector 80. Each conduit connector 78, 80 is configured to receive airflow from the air source and the particulate material from the respective metering device 72, thereby producing the air/particulate material mixture, which flows to the row unit(s). First conduits (e.g., distribution hoses) may be coupled to the first conduit connectors 78, and second conduits (e.g., distribution hoses) may be coupled to the second conduit connectors 80. Furthermore, each seed meter 66 may include a gate that enables selection of the first conduit connector 78 or the second conduit connector 80. Once the first conduit connector 78 or the second conduit connector 80 is selected, the particulate material flows through the selected conduit connector 78, 80 to the respective conduit (e.g., distribution hose) to the row unit(s).

In the illustrated embodiment, the auxiliary storage compartment 54 has an opening in a lateral side 82 of the auxiliary storage compartment 54. The opening is configured to receive particulate material from the filling assembly 56. Furthermore, the filling assembly 56 is coupled to the lateral side 82 of the auxiliary storage compartment 54, and the filling assembly 56 has an inlet 84 and an outlet 86. The outlet 86 is aligned with the opening of the auxiliary storage compartment 54, and the filling assembly 56 establishes a flow path that extends downwardly (e.g., along the vertical axis 74) and laterally inwardly (e.g., toward the auxiliary storage compartment along the lateral axis 68) from the inlet 84 to the outlet 86. While the filling assembly 56 is coupled to the lateral side 82 of the auxiliary storage compartment 54 in the illustrated embodiment, in other embodiments, the filling assembly may be coupled to other suitable portion(s) of the auxiliary storage compartment (e.g., alone or in combination with the lateral side).

In addition, the auxiliary storage compartment assembly 52 includes a conveyor assembly 88 having a rotary conveyor. The rotary conveyor extends through a portion of the filling assembly 56 and a portion of the auxiliary storage compartment 54, and the rotary conveyor is configured to move the particulate material laterally (e.g., along the lateral axis 68) through the portion of the filling assembly 56 and through the portion of the auxiliary storage compartment 54 in response to rotation of the rotary conveyor. Accordingly, the filling assembly 56 and the conveyor assembly 88 cooperate to substantially evenly distribute the particulate material along the lateral axis 68 within the auxiliary storage compartment 54. As a result, the metering system 64 may receive a substantially uniform supply of the particulate material from the auxiliary storage compartment 54 during operation of the metering system 64.

In the illustrated embodiment, the filling assembly 56 includes a fill chute 90, a fill tube 92, and a hopper 94. As illustrated, the fill chute 90 is engaged with and coupled to the lateral side 82 of the auxiliary storage compartment 54. In the illustrated embodiment, the fill chute 90 is coupled to the auxiliary storage compartment 54 by a fastener connection. However, in other embodiments, the fill chute may be coupled to the auxiliary storage compartment by any other suitable type(s) of connection(s) (e.g., alone or in combination with the fastener connection), such as a welded connection, an adhesive connection, a press-fit connection, other suitable type(s) of connection(s), or a combination thereof. In addition, while the filling assembly 56 is coupled to the auxiliary storage compartment 54 via the coupling between the fill chute 90 and the lateral side 82 of the auxiliary storage compartment 54 in the illustrated embodiment, in other embodiments, the filling assembly may be coupled to the auxiliary storage compartment via coupling the fill chute to another portion of the auxiliary storage compartment. Furthermore, in certain embodiments, another suitable component of the filling assembly may be coupled to the auxiliary storage compartment (e.g., alone or in combination with the coupling between the fill chute and the auxiliary storage compartment). In addition, the outlet 86 of the filling assembly 56 is formed at the fill chute 90, the inlet 84 of the filling assembly 56 is formed at the hopper 94, and the fill tube 92 is positioned between the hopper 94 and the fill chute 90. Accordingly, the operator may pour particulate material (e.g., from a bag, etc.) into the hopper 94, and due to the downward and laterally inward direction of the flow path established by the filling assembly 56, the particulate material flows through the hopper 94, the fill tube 92, and the fill chute 90 into the auxiliary storage compartment 54 under the influence of gravity.

In the illustrated embodiment, the hopper 94 orients the inlet 84 of the filling assembly 56 within a plane formed by the lateral axis 68 and a longitudinal axis 76 (e.g., perpendicular to the vertical axis 74, parallel to the soil surface), thereby facilitating deposition of the particulate material within the filling assembly 56. However, in other embodiments, the inlet of the filling assembly may be oriented at any suitable angle(s) relative to the plane formed by the lateral axis and the longitudinal axis. Furthermore, in the illustrated embodiment, the fill tube 92 includes a flexible hose. As discussed in detail below, the flexible hose enables the filling assembly 56 to transition from the illustrated loading state, which is configured to facilitate particulate material flow into the auxiliary storage compartment 54, to an operation state configured to facilitate operation of the metering system. While the fill tube 92 includes a single flexible hose in the illustrated embodiment, in other embodiments, the fill tube may include other/additional suitable type(s) of conduit(s) (e.g., one or more substantially rigid conduits, multiple flexible hoses, etc.). In addition, the fill tube 92 has a substantially circular cross-sectional shape in the illustrated embodiment. However, in other embodiments, the fill tube may have any other suitable cross-sectional shape (e.g., polygonal, elliptical, etc.). Furthermore, the fill chute 90 has a square cross-sectional shape in the illustrated embodiment. However, in other embodiments, the fill chute may have any other suitable cross-sectional shape.

In the illustrated embodiment, the filling assembly 56 includes a lid 96 configured to selectively block the inlet 84 of the filling assembly 56. The lid 96 may be transitioned to the illustrated open position to enable particulate material to enter the filling assembly 56, and the lid 96 may be transitioned to a closed position to block particulate material from entering the filling assembly 56. The lid 96 may be transitioned to the illustrated open position during loading operations (e.g., while the filling assembly 56 is in the illustrated loading state), and the lid 96 may be transitioned to the closed position to block dirt and/or debris from entering the filling assembly 56. In the illustrated embodiment, the lid 96 is pivotally coupled to the hopper 94, thereby enabling the lid 96 to pivot between the open and closed positions. In the illustrated embodiment, the rotation of lid 96 away from the inlet 84 is blocked while the lid 96 is in the open position, thereby establishing an angled lid surface extending toward the inlet 84. Accordingly, the lid may direct particulate material toward the inlet 84 while the lid 96 is in the illustrated open position. Furthermore, in the illustrated embodiment, the lid 96 includes a tab 98 configured to facilitate pivoting the lid 96 between the open and closed positions. However, in other embodiments, the tab may be omitted and/or the lid may include other suitable feature(s) to facilitate pivoting the lid between the open and closed positions (e.g., a handle, a motor, etc.). While the lid 96 is configured to pivot between the open and closed positions in the illustrated embodiment, in other embodiments, the lid may be slidably coupled to the hopper, or the lid may be removably coupled to the hopper. Furthermore, while the filling assembly 56 includes the lid 96 in the illustrated embodiment, in other embodiments, the lid may be omitted.

In the illustrated embodiment, the filling assembly 56 includes a fill tray 100 configured to direct the particulate material toward the inlet 84 of the filling assembly 56. As illustrated, the fill tray 100 includes side plates 102 configured to block movement of the particulate material along the longitudinal axis 76. Furthermore, in the illustrated embodiment, the fill tray 100 is configured to move (e.g., rotate and/or translate) between the illustrated loading position (e.g., while the filling assembly 56 is in the illustrated loading state) and a stowage position (e.g., while the filling assembly 56 is in the operation state). While the fill tray 100 is configured to move between the loading position and the stowage position in the illustrated embodiment, in other embodiments, the fill tray may be fixed in the loading position. Furthermore, in certain embodiments, the fill tray may be omitted.

In the illustrated embodiment, the conveyor assembly 88 includes a motor assembly 104 configured to drive the rotary conveyor in rotation. The motor assembly 104 may include any suitable type(s) of motor(s), such as a hydraulic motor, an electric motor, or a pneumatic motor. Furthermore, the motor assembly 104 may include a transmission, a clutch, a gear assembly, other suitable component(s), or a combination thereof. In the illustrated embodiment, the motor assembly 104 is coupled to the fill chute 90, and an opening in the fill chute 90 facilitates passage of a portion of the motor assembly 104 into an interior of the fill chute 90. Coupling the motor assembly 104 to the fill chute 90 may reduce the overall size/dimensions of the auxiliary storage compartment assembly 52 (e.g., as compared to a motor assembly positioned external to the auxiliary storage compartment on an opposite lateral side of the auxiliary storage compartment from the filling assembly). While the motor assembly 104 is coupled to the fill chute 90 in the illustrated embodiment, in other embodiments, the motor assembly may be coupled to another suitable component of the filling assembly, the platform assembly, or the auxiliary storage compartment. In the illustrated embodiment, the conveyor assembly 88 includes a speed controller 106 communicatively coupled (e.g., fluidly coupled, electrically coupled, etc.) to the motor assembly 104 and configured to control a rotation speed of the rotary conveyor. For example, the speed controller may control a flow rate of fluid to a hydraulic or pneumatic motor of the motor assembly, or the speed controller may control electrical power output to an electric motor of the motor assembly. The speed controller 106 includes a handle in the illustrated embodiment. However, in other embodiments, the speed controller may include a knob, a switch, or any other suitable controller. Furthermore, in certain embodiments, the speed controller may be omitted.

As previously discussed, the auxiliary storage compartment assembly 52 includes a platform assembly 58 positioned adjacent to the auxiliary storage compartment 54. The platform assembly 58 includes a platform 108 configured to support an operator, thereby enabling the operator to load/pour the particulate material (e.g., from a bag, etc.) into the filling assembly 56. In the illustrated embodiment, the platform assembly 58 includes railings 110 configured to block movement of the operator away from the platform 108 and to provide handholds for the operator. However, in other embodiments, at least a portion of the railings (e.g., all of the railings) may be omitted. Furthermore, in the illustrated embodiment, the platform assembly 58 includes a ladder 112 coupled to the platform 108. The ladder 112 is configured to facilitate access to the platform 108. In the illustrated embodiment, the ladder 112 is configured to rotate from the illustrated loading position (e.g., while the filling assembly is in the loading state) to a stowage position (e.g., while the filling assembly is in the operation state). The ladder 112 may rotate upwardly about the longitudinal axis 76 from the illustrated loading position to the stowage position, thereby substantially reducing or eliminating the possibility of the ladder 112 engaging the soil surface while the air cart is moving through the agricultural field. In certain embodiments, the platform assembly 58 includes a locking mechanism configured to block rotation of the ladder 112 while the ladder is in the loading position and while the ladder is in the stowage position. For example, the locking mechanism may include a pin, a latch, a fastener, another suitable component, or a combination thereof. In addition, while the ladder is configured to pivot between the loading position and the stowage position in the illustrated embodiment, in other embodiments, the ladder may be configured to translate between the loading and stowage positions, or the ladder may be fixed to the platform. While the platform assembly 58 includes the ladder 112 in the illustrated embodiment, in other embodiments, the ladder may be omitted.

In the illustrated embodiment, the platform assembly 58 includes a support frame 114 coupled to the platform 108 and configured to support the hopper 94. For example, the support frame may be coupled to the hopper 94 via any suitable type(s) of connection(s), such as a fastener connection, a welded connection, an adhesive connection, other suitable type(s) of connection(s), or a combination thereof. The support frame 114 may include any suitable number and/or configuration of support elements (e.g., including tube(s), rod(s), bar(s), etc.). In the illustrated embodiment, the speed controller 106 is coupled to the support frame 114 and configured to be positioned proximate to the operator while the operator is on the platform 108, thereby facilitating operator control of the rotation speed of the rotary conveyor. However, in other embodiments, the speed controller may be coupled to any suitable component of the auxiliary storage compartment assembly.

In the illustrated embodiment, the auxiliary storage compartment assembly 52 includes auxiliary storage compartment mounts 116 configured to couple the auxiliary storage compartment 54 to the frame of the air cart. In addition, the auxiliary storage compartment assembly 52 includes platform mounts 118 configured to couple the platform 108 to the frame of the air cart. The auxiliary storage compartment mounts 116 are separate from the platform mounts 118. Accordingly, the platform 108 mounts to the frame of the air cart independently of the auxiliary storage compartment 54. In addition, the other components of the platform assembly 58 are coupled to the frame of the air cart via the platform 108. As such, the entire platform assembly 58 is supported by the frame of the air cart, and the platform assembly 58 is coupled to the frame of the air cart independently of the auxiliary storage compartment 54. In certain embodiments, at least one component of the platform assembly, other than the platform, may be mounted to the frame of the air cart independently of the auxiliary storage compartment (e.g., in addition to or as an alternative to the coupling between the platform and the air cart frame). Because the auxiliary storage compartment is mounted to the frame of the air cart independently of the platform assembly, weight sensor(s) (e.g., strain gauge(s), load cell(s), etc.) may be used to monitor the weight of the auxiliary storage compartment (e.g., after loading, during operation of the metering system, etc.) without interference from the platform assembly (e.g., while the filling assembly 56 is in the operation state). While the auxiliary storage compartment 54 and the platform assembly 58 are coupled to the air cart frame with mounts in the illustrated embodiment, in other embodiments, at least one of the auxiliary storage compartment or the platform assembly may be coupled to the air cart frame by other/additional suitable connection(s) (e.g., including a fastener connection, a welded connection, an adhesive connection, etc.). Furthermore, while the platform assembly 58 is coupled to the frame of the air cart independently of the auxiliary storage compartment 54 in the illustrated embodiment, in other embodiments, the auxiliary storage compartment may be coupled to the air cart frame via the platform assembly, or the platform assembly may be coupled to the air cart frame via the auxiliary storage compartment. In addition, while the auxiliary storage compartment assembly 52 includes the platform assembly 58 in the illustrated embodiment, in other embodiments, the platform assembly may be omitted.

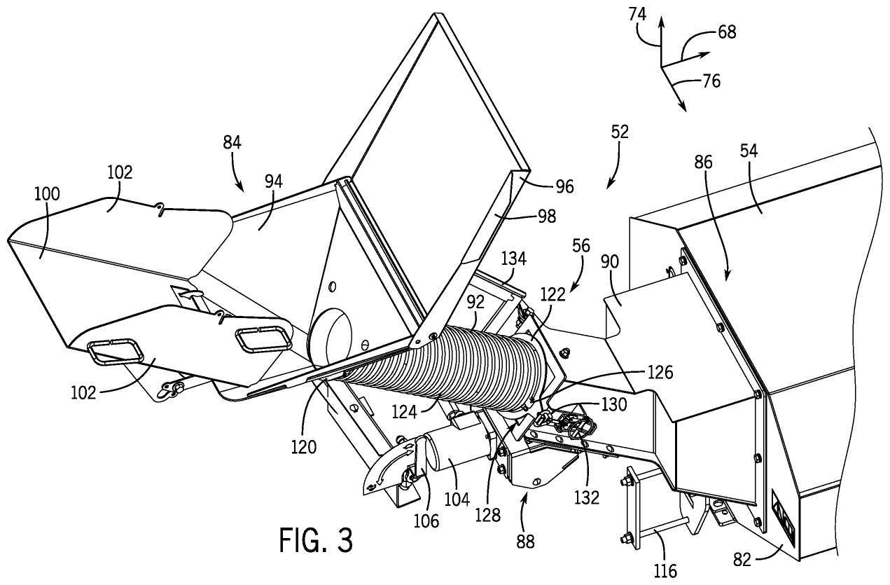

FIG. 3 is a top perspective view of a portion of the auxiliary storage compartment assembly 52 of FIG. 2. As previously discussed, the fill tube 92 is positioned between the hopper 94 and the fill chute 90 (e.g., while the filling assembly is in the illustrated loading state). In the illustrated embodiment, the fill tube 92 is coupled to the hopper 94 by a hose clamp 120. However, in other embodiments, the fill tube may be coupled to the hopper by any other suitable type(s) of connection(s) (e.g., alone or in combination with the hose clamp), such as a fastener connection, an adhesive connection, a welded connection, etc.). In the illustrated embodiment, the fill tube 92 includes a connector 122 coupled to the flexible hose 124 by a hose clamp 126. However, in other embodiments, the flexible hose may be coupled to the connector by any other suitable type(s) of connection(s) (e.g., alone or in combination with the hose clamp), such as a fastener connection, an adhesive connection, a welded connection, etc.). Furthermore, in certain embodiments, the connector may be omitted.

In the illustrated embodiment, the connector 122 of the fill tube 92 engages the fill chute 90 at an inlet 128 of the fill chute 90. Accordingly, the particulate material may flow through the fill tube 92 into the fill chute 90. In the illustrated embodiment, the inlet 128 of the fill chute 90 is square. However, in other embodiments, the inlet of the fill chute may have any other suitable shape (e.g., round, elliptical, etc.). For example, in certain embodiments, the inlet of the fill chute may have a shape that substantially matches the shape of the connector of the fill tube.

In the illustrated embodiment, the connector 122 of the fill tube 92 is coupled to the fill chute 90 by a latch 130. The latch 130 is configured to secure the fill tube 92 to the fill chute 90 while engaged and to enable removal of the fill tube 92 from the fill chute 90 while disengaged. In the illustrated embodiment, a pin 132 is configured to block disengagement of the latch 130 while the latch 130 is engaged. Accordingly, to disengage the fill tube 92 from the fill chute 90, the pin 132 is removed from the latch 130, and the latch 130 is disengaged. In addition, to secure the fill tube 92 to the fill chute 90, the connector 122 of the fill tube 92 is engaged with the fill chute 90 at the inlet 128, the latch 130 is engaged with the connector 122, and the pin 132 is engaged with the latch 130. While the pin 132 is used to block disengagement of the latch 130 in the illustrated embodiment, in other embodiments, the pin may be omitted. Furthermore, while one latch is used to secure the fill tube to the fill chute in the illustrated embodiment, in other embodiments, multiple latches (e.g., 2, 3, 4, or more) may be used to secure the fill tube to the fill chute. In addition, in certain embodiments, other suitable coupling device(s) (e.g., alone or in combination with the latch(es)), such as fastener(s), pin(s), cam(s), etc., may be used to secure the fill tube to the fill chute. Furthermore, in certain embodiments, the filling assembly may not include any device configured to couple the fill tube to the fill chute.

In the illustrated embodiment, the filling assembly 56 includes a door 134 configured to move between the illustrated open position and a closed position to selectively block the inlet 128 of the fill chute 90 while the fill tube 92 is not engaged with the fill chute 90. While the door 134 is in the illustrated open position (e.g., while the filling assembly 56 is in the loading state), the fill tube 92 may be engaged with the fill chute 90 (e.g., the connector 122 of the fill tube 92 may be engaged with the fill chute 90 at the inlet 128). In addition, while the door 134 is in the closed position (e.g., while the filling assembly 56 is in the operation state), the door 134 blocks the inlet 128 of the fill chute 90. While the door 134 is in the closed position, the door 134 may block flow of the particulate material. In addition, the door 134 may substantially block airflow out of the fill chute 90, thereby facilitating pressurization of the auxiliary storage compartment 54, which may enhance the flow of the particulate material through the metering system. In the illustrated embodiment, the door 134 is pivotally coupled to the fill chute 90 and configured to pivot between the illustrated open position and the closed position. However, in other embodiments, the door may translate (e.g., slide) between the open and closed positions, or the door may be removably coupled to the fill chute. In the illustrated embodiment, the latch 130 is configured to secure the door 134 in the closed position, thereby facilitating pressurization of the auxiliary storage compartment 54. For example, to transition the filling assembly 56 to the operation state, the pin 132 may be disengaged from the latch 130, the latch 130 may be disengaged from the connector 122, the fill tube 92 may be disengaged from the fill chute 90, the door 134 may be transitioned to the closed position, the latch 130 may be engaged with the door 134, and the pin 132 may be engaged with the latch 130. In addition, to transition the filling assembly 56 to the loading state, the pin 132 may be disengaged from the latch 130, the latch 130 may be disengaged from the door 134, the door 134 may be transitioned to the open position, the fill tube 92 may be engaged with the fill chute 90, the latch 130 may be engaged with the connector 122, and the pin 132 may be engaged with the latch 130.

While the door 134 is secured in the closed position by the same latch 130 used to secure the connector 122 of the fill tube 92 to the fill chute 90 in the illustrated embodiment, in other embodiments, the door and the fill tube may be secured by different device(s). In addition, while one latch is used to secure the door in the closed position in the illustrated embodiment, in other embodiments, multiple latches (e.g., 2, 3, 4, or more) may be used to secure the door in the closed position. Furthermore, in certain embodiments, other suitable coupling device(s) (e.g., alone or in combination with the latch(es)), such as fastener(s), pin(s), cam(s), etc., may be used to secure the door in the closed position. While the filling assembly 56 includes the fill chute 90, the fill tube 92, and the hopper 94 in the illustrated embodiment, in other embodiments, the filling assembly may include other/additional component(s) to establish the flow path that extends downwardly and laterally inwardly from the inlet to the outlet of the filling assembly.

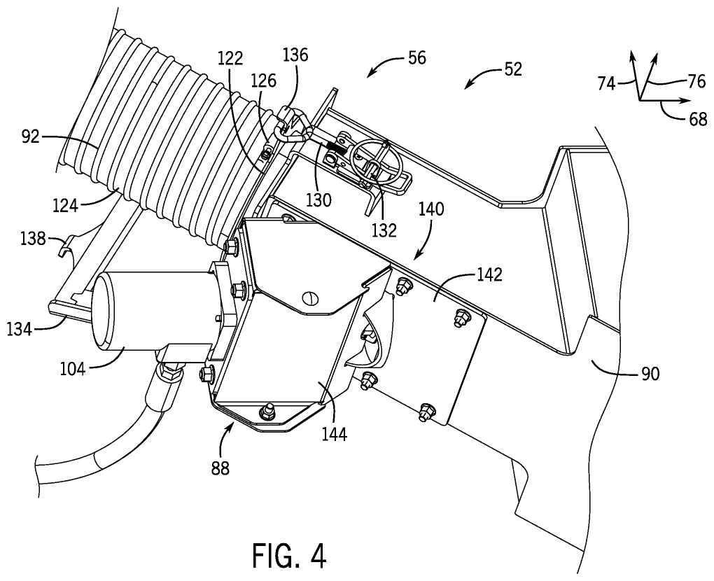

FIG. 4 is a bottom perspective view of a portion of the auxiliary storage compartment assembly 52 of FIG. 2. As previously discussed, the latch 130 is configured to secure the fill tube 92 to the fill chute 90 while engaged and to enable removal of the fill tube 92 from the fill chute 90 while disengaged. In the illustrated embodiment, the connector 122 of the fill tube 92 includes a protrusion 136, and the latch 130 is configured to engage the protrusion 136 to secure the fill tube 92 to the fill chute 90. While the connector 122 includes the protrusion 136 in the illustrated embodiment, in other embodiments, the connector and/or another element of the fill tube may include other suitable element(s) (e.g., alone or in combination with the protrusion) configured to engage the latch. Furthermore, in embodiments having multiple latches, the fill tube may include corresponding protrusion(s)/element(s).

Furthermore, as previously discussed, the latch 130 is configured to secure the door 134 in the closed position. In the illustrated embodiment, the door 134 includes a protrusion 138, and the latch 130 is configured to engage the protrusion 138 to secure the door 134 in the closed position. While the door 134 includes the protrusion 138 in the illustrated embodiment, in other embodiments, the door may include other suitable element(s) (e.g., alone or in combination with the protrusion) configured to engage the latch. Furthermore, in embodiments having multiple latches, the door may include corresponding protrusion(s)/element(s).

In addition, as previously discussed, the motor assembly 104 is coupled to the fill chute 90, and an opening in the fill chute 90 facilitates passage of a portion of the motor assembly 104 into an interior of the fill chute 90. In the illustrated embodiment, the motor assembly 104 is coupled to the fill chute 90 by a mounting assembly 140. The mounting assembly 140 includes a cover plate 142 configured to cover a portion of the opening in the fill chute 90. In the illustrated embodiment, the motor assembly 104 is coupled to the mounting assembly 140 by a fastener connection. However, in other embodiments, the motor assembly may be coupled to the mounting assembly by other suitable type(s) of connection(s) (e.g., alone or in combination with the fastener connection), such as an adhesive connection, a welded connection, a press-fit connection, other suitable type(s) of connection(s), or a combination thereof. Furthermore, a cover structure 144 is disposed about a portion of the motor assembly 104. The cover structure 144 may be coupled to the mounting assembly 140 by any suitable type(s) of connection(s), such as a fastener connection, an adhesive connection, a welded connection, other suitable type(s) of connection(s), or a combination thereof. In addition, in the illustrated embodiment, the cover plate 142 of the mounting assembly 140 is coupled to the fill chute 90 by a fastener connection. However, in other embodiments, the cover plate may be coupled to the fill chute by other suitable type(s) of connection(s) (e.g., alone or in combination with the fastener connection), such as an adhesive connection, a welded connection, other suitable type(s) of connection(s), or a combination thereof. While the mounting assembly 140 includes the cover plate 142 in the illustrated embodiment, in other embodiments, the cover plate may be omitted, and/or the mounting assembly may include any other suitable element(s) configured to couple the motor assembly to the fill chute. Furthermore, in certain embodiments, the mounting assembly may be omitted, and the motor assembly may be directly coupled to the fill chute. In addition, in certain embodiments, the cover structure may be omitted.

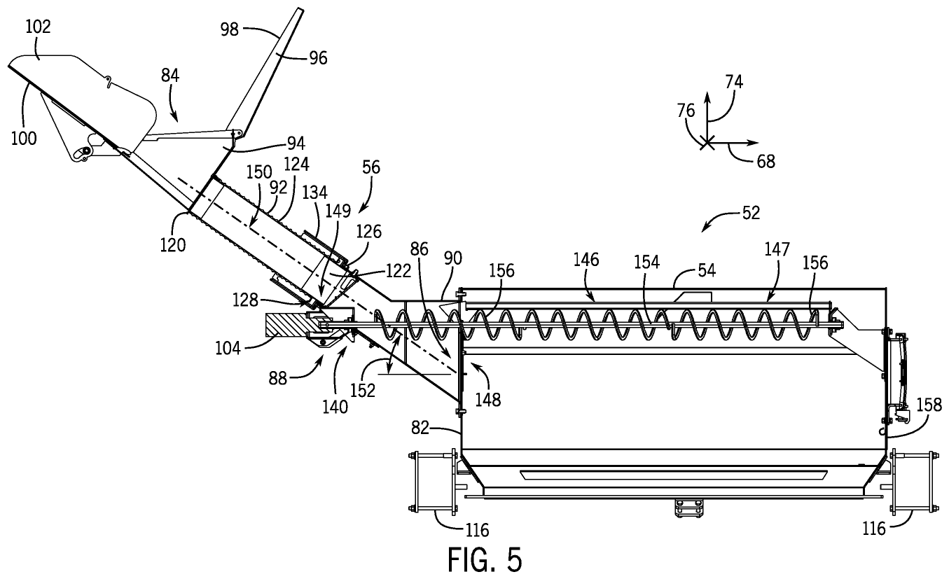

FIG. 5 is a cross-sectional view of a portion of the auxiliary storage compartment assembly 52 of FIG. 2. As previously discussed, the conveyor assembly 88 includes a rotary conveyor 146 that extends through the fill chute 90 of the filling assembly 56 and a portion 147 of the auxiliary storage compartment 54. The rotary conveyor 146 is configured to move particulate material laterally (e.g., along the lateral axis 68) through the fill chute 90 and through the portion 147 of the auxiliary storage compartment 54 in response to rotation of the rotary conveyor 146. Furthermore, as previously discussed, the motor assembly 104 of the conveyor assembly 88 is configured to drive the rotary conveyor 146 in rotation. While the rotary conveyor 146 extends through the fill chute 90 of the filling assembly 56 in the illustrated embodiment, in other embodiments (e.g., embodiments that do not include a fill chute), the rotary conveyor may extend through another suitable portion of the filling assembly (e.g., the portion of the filling assembly that forms the outlet of the filling assembly). Furthermore, in certain embodiments, the motor assembly may be positioned on an opposite side of the auxiliary storage compartment from the filling assembly. In such embodiments, the rotary conveyor may extend through a portion of the filling assembly (e.g., the fill chute), or the rotary conveyor may not extend through any portion of the filling assembly.

As previously discussed, the motor assembly 104 is coupled to the fill chute 90, and the motor assembly 104 extends through an opening 149 in the fill chute 90, such that a portion of the motor assembly 104 is disposed within an interior of the fill chute 90. While only a portion of the motor assembly 104 is disposed within the interior of the fill chute 90 in the illustrated embodiment, in other embodiments, an entirety of the motor assembly may be disposed within the fill chute. In such embodiments, the motor assembly may be coupled to the fill chute, and the opening in the fill chute may be omitted. Furthermore, in certain embodiments, at least a portion of the motor assembly (e.g., an entirety of the motor assembly) may be disposed within an interior of the auxiliary storage compartment. In such embodiments, the motor assembly may be coupled to the fill chute and/or to the auxiliary storage compartment, and the opening in the fill chute may be omitted.

As previously discussed, the outlet 86 of the filling assembly 56 is aligned with an opening 148 of the auxiliary storage compartment 54. Accordingly, particulate material may flow from the filling assembly 56 into the auxiliary storage compartment 54. In addition, the filling assembly 56 establishes a flow path 150 that extends downwardly (e.g., along the vertical axis 74) and laterally inwardly (e.g., toward the auxiliary storage compartment 54 along the lateral axis 68) from the inlet 84 to the outlet 86. Accordingly, particulate material deposited/poured into the inlet 84 flows downwardly and laterally inwardly along the flow path 150 to the auxiliary storage compartment 54. In addition, in response to rotation of the rotary conveyor 146, the rotary conveyor 146 drives the particulate material to move laterally through the fill chute 90 and through the portion 147 of the auxiliary storage compartment 54. Accordingly, the filling assembly 56 and the conveyor assembly 88 cooperate to substantially evenly distribute the particulate material along the lateral axis 68 within the auxiliary storage compartment 54. As a result, the metering system may receive a substantially uniform supply of the particulate material from the auxiliary storage compartment 54 during operation of the metering system.

The flow path 150 may be oriented at a suitable angle 152 relative to the lateral axis 68 (e.g., average angle of the flow path, angle of the flow path at the filling assembly outlet, etc.) to facilitate the even distribution of the particulate material along the lateral axis 68 within the auxiliary storage compartment 54. For example, a steeper angle may increase the exit speed of the particulate material from the outlet 86, and a shallower angle may increase the lateral component of the exit speed. Accordingly, an angle that enhances the even distribution of the particulate material along the lateral axis may be selected. For example, the angle 152 may be selected based on an expected angle of repose (e.g., maximum expected angle of repose) of the particulate material to facilitate effective flow of the particulate material through the flow path 150. In certain embodiments, the filling assembly 56 (e.g., the fill chute 90 of the filling assembly 56) may be configured to orient the flow path 150 at an angle 152 of about 20 degrees to about 50 degrees, about 25 degrees to about 45 degrees, about 30 degrees to about 40 degrees, or about 35 degrees relative to the lateral axis 68.

In the illustrated embodiment, the rotary conveyor 146 includes a central shaft 154 and open coil(s) 156 coupled (e.g., non-movably coupled and non-rotatably coupled) to the central shaft 154. The central shaft 154 is coupled to the motor assembly 104, and the motor assembly 104 is configured to drive the central shaft 154 to rotate (e.g., about the lateral axis 68). Because the open coil(s) 156 are coupled to the central shaft 154, the open coil(s) 156 are also configured to be driven to rotate by the motor assembly 104. Rotation of the open coil(s) 156 drives the particulate material to move along the lateral axis 68 away from the opening 148 (e.g., toward an opposite lateral side 158 of the auxiliary storage compartment 54), while enabling the particulate material to pass through the open coil(s) 156. As a result, compaction of the particulate material by the open coil rotary conveyor may be substantially reduced or eliminated (e.g., as compared to an auger with closed spiral flight(s)). The rotary conveyor may have any suitable number of open coils coupled to the central shaft (e.g., 1, 2, 3, 4, 5, 6, or more), and each open coil may have any suitable lateral extent and/or number of loops/turns. In embodiments having multiple open coils, at least two rotary coils may overlap one another along the lateral axis, and/or at least two rotary coils may be spaced apart from one another along the lateral axis. Furthermore, the motor assembly 104 may be configured to drive the rotary conveyor 146 at any suitable rotation speed, such as 100 to 700 RPM, 200 to 600 RPM, 300 to 500 RPM, or 300 to 400 RPM. For example, the motor assembly 104 may drive the rotary conveyor 146 at a sufficient rotation speed to enable the particulate material to substantially continuously flow through the flow path 150. As previously discussed, the conveyor assembly 88 may include a speed controller configured to control the rotation speed of the rotary conveyor 146.

While the open coil(s) 156 extend through the fill chute 90/portion of the filling assembly 56 in the illustrated embodiment, in other embodiments, the open coil(s) may only be positioned within the auxiliary storage compartment. In addition, while the rotary conveyor 146 includes open coil(s) 156 in the illustrated embodiment, in other embodiments, the rotary conveyor may include other suitable element(s) (e.g., alone or in combination with the open coil(s)), such as protrusion(s), paddle(s), open spiral flight(s), closed spiral flight(s), other suitable element(s), or a combination thereof. Furthermore, in the illustrated embodiment, the rotary conveyor 146 is positioned at an upper region of the auxiliary storage compartment 54. However, in other embodiments, the rotary conveyor may be positioned at a middle region or at a lower region of the auxiliary storage compartment. In addition, in the illustrated embodiment, the conveyor assembly 88 includes a single rotary conveyor 146. However, in other embodiments, the conveyor assembly may include multiple rotary conveyors (e.g., 2, 3, 4, 5, 6, or more), and the rotary conveyors may be distributed along the vertical axis, the lateral axis, the longitudinal axis, or a combination thereof.

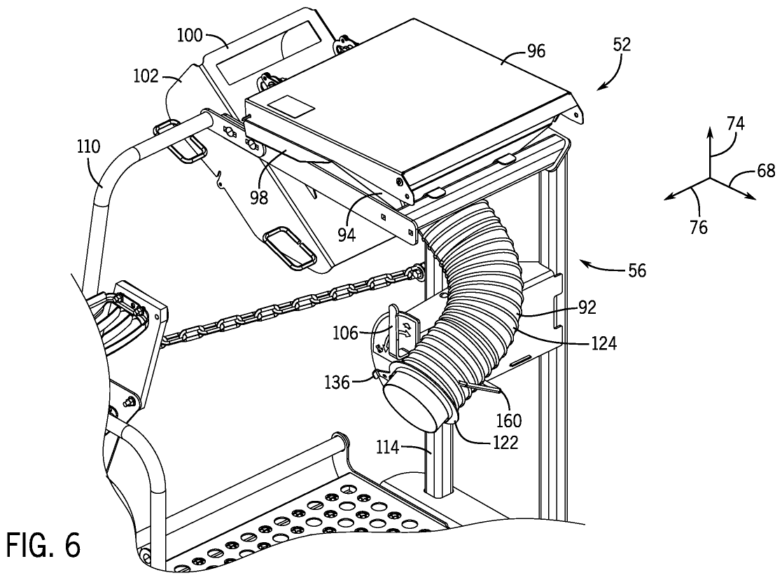

FIG. 6 is a perspective view of a portion of the auxiliary storage compartment assembly 52 of FIG. 2, in which the filling assembly 56 of the auxiliary storage compartment assembly 52 is in the operation state. As previously discussed, the flexible hose 124 of the fill tube 92 enables the filling assembly 56 to transition from the loading state, which is configured to facilitate particulate material flow into the auxiliary storage compartment, to the illustrated operation state configured to facilitate operation of the metering system. To transition the filling assembly 56 from the loading state to the operation state, the latch is disengaged from the protrusion 136 of the connector 122 of the fill tube 92, the fill tube 92 is disengaged from the fill chute, the door is transitioned from the open position to the closed position, and the latch is engaged with the protrusion of the door to secure the door in the closed position. In addition, the fill tray 100 is transitioned (e.g., pivoted) from the loading position to the illustrated stowage position, and the lid 96 is transitioned from the open position to the illustrated close position. In the illustrated embodiment, the filling assembly 56 includes a retainer 160 configured to secure the flexible tube 124 to the support frame 114 while the fill tube 92 is disengaged from the fill chute. While the filling assembly 56 includes the retainer 160 configured to secure the flexible tube 124 to the support frame 114 in the illustrated embodiment, in other embodiments, the retainer may be omitted, or the retainer may be configured to secure the flexible tube to another suitable structure. Furthermore, in certain embodiments, the filling assembly may include a locking mechanism (e.g., pin, latch, etc.) configured to selectively secure the lid in the closed position.

As previously discussed, because the auxiliary storage compartment is mounted to the frame of the air cart independently of the platform assembly, weight sensor(s) (e.g., strain gauge(s), load cell(s), etc.) may be used to monitor the weight of the auxiliary storage compartment (e.g., after loading, during operation of the metering system, etc.) without interference from the platform assembly (e.g., while the filling assembly 56 is in the illustrated operation state). In addition, because the fill tube 92 is disengaged from the fill chute, the fill tube 92, the hopper 94, the lid 96, and the fill tray 100 may not interfere with the weight monitoring of the auxiliary storage compartment. Accordingly, the accuracy of a determined weight of the particulate material within the auxiliary storage compartment (e.g., determined by subtracting the weight of the auxiliary storage compartment structure) may be enhanced.

While the fill tube 92 includes a single flexible hose in the illustrated embodiment, in other embodiments, the fill tube may include other/additional suitable type(s) of conduit(s) (e.g., one or more substantially rigid conduits, multiple flexible hoses, etc.). For example, in certain embodiments, the fill tube may include multiple substantially rigid conduits coupled to one another by flexible joint(s)/flexible hose(s). In such embodiments, the fill tube may be disengaged from the fill chute by bending the fill tube at the flexible joint(s)/flexible hose(s). Furthermore, in certain embodiments, the fill tube may not be flexible/bendable. In such embodiments, the filling assembly may be transitioned from the loading state to the operation state by removing and stowing the fill tube. In addition, in certain embodiments, the filling assembly may not be transitioned between the loading and operation states. Furthermore, in certain embodiments, the filling assembly and the conveyor assembly may be elements of a kit (e.g., retrofit kit) configured to interface with the auxiliary storage compartment of an existing air cart to enhance the process of loading particulate material into the auxiliary storage compartment. While the filling assembly and the conveyor assembly are disclosed above with regard to an auxiliary storage compartment, the filling assembly and the conveyor assembly disclosed herein may also be used with another suitable storage compartment (e.g., a primary storage compartment) of an air cart or another suitable type of machine.

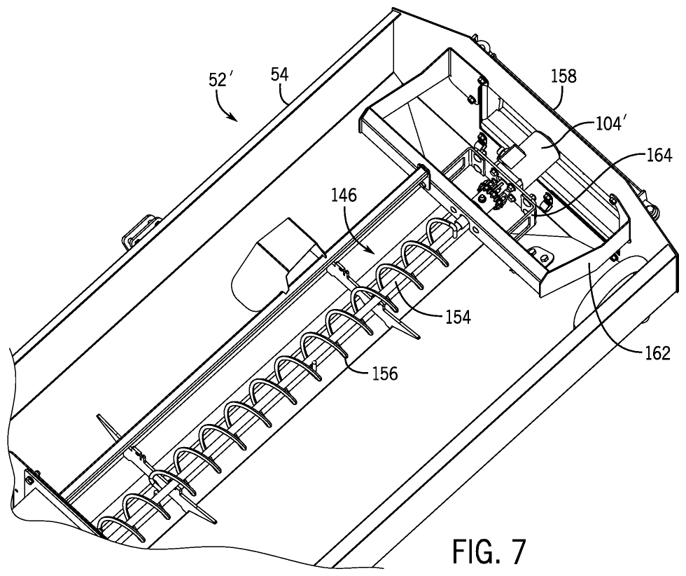

FIG. 7 is a perspective view of a portion of another embodiment of an auxiliary storage compartment assembly 52′ that may be employed within the air cart of FIG. 1. In the illustrated embodiment, the motor assembly 104′ is disposed within the auxiliary storage compartment 54 (e.g., within an interior of the auxiliary storage compartment 54). As previously discussed, the motor assembly 104′ is configured to drive the rotary conveyor 146 in rotation. As illustrated, the motor assembly 104′ is coupled to the central shaft 154 of the rotary conveyor 146, and the motor assembly 104′ is positioned at an opposite end of the central shaft 154 from the position of the motor assembly disclosed above with reference to FIGS. 4-6. In the illustrated embodiment, the motor assembly 104′ is positioned proximate to the opposite lateral side 158 of the auxiliary storage compartment 54. However, in other embodiments, the motor assembly may be positioned at any suitable location within the auxiliary storage compartment (e.g., at the same end of the central shaft as the motor assembly disclosed above with reference to FIGS. 4-6). Disposing the motor assembly 104′ within the auxiliary storage compartment 54 may reduce the overall size/dimensions of the auxiliary storage compartment assembly 52′ (e.g., as compared to a motor assembly positioned external to the auxiliary storage compartment on an opposite lateral side of the auxiliary storage compartment from the filling assembly).

In the illustrated embodiment, the auxiliary storage compartment assembly 52′ includes a mount 162 coupled to the auxiliary storage compartment 54 and configured to support the rotary conveyor 146. In the illustrated embodiment, the mount 162 is coupled to the auxiliary storage compartment 54 by a fastener connection. However, in other embodiments, the mount may be coupled to the auxiliary storage compartment by other suitable type(s) of connection(s) (e.g., alone or in combination with the fastener connection), such as an adhesive connection, a welded connection, other suitable type(s) of connection(s), or a combination thereof. Furthermore, the central shaft 154 is rotatably coupled to the mount 162 (e.g., via a bearing). In the illustrated embodiment, the auxiliary storage compartment assembly 52′ includes a bracket 164 coupled to the mount 162 (e.g., via a fastener connection, a welded connection, an adhesive connection, other suitable type(s) of connection(s), or a combination thereof). In addition, the motor assembly 104′ is coupled to the bracket 164 (e.g., via a fastener connection, a welded connection, an adhesive connection, other suitable type(s) of connection(s), or a combination thereof). Accordingly, the motor assembly 104′ is coupled to the auxiliary storage compartment 54 via the bracket 164 and the mount 162.

In certain embodiments, the central shaft 154 is rotatably coupled to the mount 162 via a bearing. However, in other embodiments, the central shaft may be rotatably coupled to the mount only via the motor assembly (e.g., the end of the central shaft proximate to the motor assembly may only be supported by the motor assembly). Furthermore, while the motor assembly 104′ is coupled to the mount 162 via the bracket 164 in the illustrated embodiment, in other embodiments, the bracket may be omitted, and the motor assembly may be directly coupled to the mount. In addition, in certain embodiments, the motor assembly may be directly coupled to the auxiliary storage compartment (e.g., alone or in combination with the coupling to the bracket or the mount).

In the illustrated embodiment, the motor assembly 104′ is disposed entirely within the auxiliary storage compartment 54. However, in other embodiments, a portion of the motor assembly may be disposed outside of the auxiliary storage compartment. For example, the auxiliary storage compartment may include an opening in the opposite lateral side of the auxiliary storage compartment (e.g., the side of the storage compartment opposite from the filling assembly). The opening may facilitate passage of a portion of the motor assembly into the interior of the auxiliary storage compartment, while another portion of the motor assembly is disposed outside of the auxiliary storage compartment. In certain embodiments, a cover plate may be coupled to the auxiliary storage compartment to cover a portion of the opening in the auxiliary storage compartment.

While the motor assembly 104′ of the illustrated auxiliary storage compartment assembly 52′ is disposed within the auxiliary storage compartment 54, the remaining elements of the auxiliary storage compartment assembly 52′ may be the same as the auxiliary storage compartment assembly disclosed above with reference to FIGS. 2-6 (e.g., in which like characters represent like elements). Accordingly, any of the details and variations disclosed above with regard to the auxiliary storage compartment assembly of FIGS. 2-6 may apply to the illustrated auxiliary storage compartment assembly 52′, except with regard to the location of the motor assembly and details of the mounting assembly for the motor assembly, the cover plate, and the cover structure.

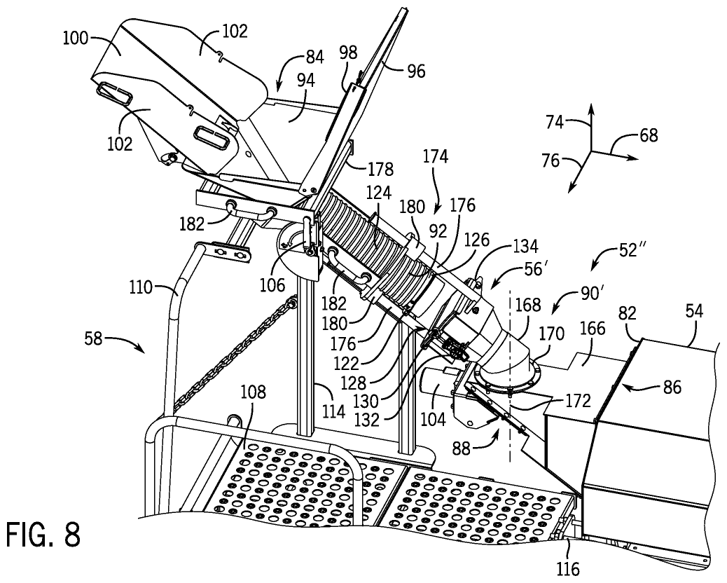

FIG. 8 is a perspective view of a portion of a further embodiment of an auxiliary storage compartment assembly 52″ that may be employed within the air cart of FIG. 1. In the illustrated embodiment, the fill chute 90′ includes a first portion 166 and a second portion 168. The first portion 166 is engaged with the lateral side 82 of the auxiliary storage compartment 54, and the second portion 168 is configured to engage the fill tube 92 (e.g., the connector 122 of the fill tube 92). The fill chute 90′ also includes a pivot joint 170 pivotally coupling the first portion 166 and the second portion 168 to one another. The pivot joint 170 enables the fill tube 92 and the hopper 94 to move relative to the auxiliary storage compartment 54. In addition, the pivot joint 170 is configured to facilitate passage of the particulate material through the fill chute 90′.

The pivot joint 170 may include any suitable component(s) configured to facilitate rotation of the second portion 168 of the fill chute 90′ relative to the first portion 166 of the fill chute 90′ and to facilitate passage of the particulate material through the pivot 170, such as collar(s), bushing(s), bearing(s), fastener(s), other suitable component(s), or a combination thereof. Furthermore, in the illustrated embodiment, the pivot joint 170 is configured to establish a pivot axis 172 aligned with the vertical axis 74. However, in other embodiments, the pivot axis may be oriented at an angle relative to the vertical axis 74, the lateral axis 68, the longitudinal axis 76, or a combination thereof. Because the pivot joint 170 enables the hopper 94 to move relative to the auxiliary storage compartment 54, the operator may position the hopper 94 at a suitable and/or convenient position for loading the particulate material into the filling assembly 56′. Furthermore, in the illustrated embodiment, the door 134 is pivotally coupled to the second portion 168 of the fill chute 90′. As previously discussed, the latch 130 is configured to secure the door 134 in the closed position, and while the door is in the open position, the latch 130 may engage the connector 122 of the fill tube 92 to couple the fill tube to the second portion 168 of the fill chute 90′.

In the illustrated embodiment, the filling assembly 56′ includes a telescoping mechanism 174 configured to facilitate extension and retraction of the fill tube 92 to adjust a distance between the hopper 94 and the fill chute 90′. In the illustrated embodiment, the telescoping mechanism 174 includes two rods 176 coupled to the second portion 168 of the fill chute 90. Each rod 176 may be coupled to the fill chute 90 via any suitable type(s) of connection(s), such as a welded connection, a fastener connection, an adhesive connection, other suitable type(s) of connection(s), or a combination thereof. In addition, the telescoping mechanism 174 includes a frame 178 coupled to the hopper 94. The frame 178 may be coupled to the hopper 94 via any suitable type(s) of connection(s), such as a welded connection, a fastener connection, an adhesive connection, other suitable type(s) of connection(s), or a combination thereof. In the illustrated embodiment, the frame 178 includes two sliders 180, and each slider 180 is engaged with a respective rod 176, thereby establishing a slidable connection between the frame 178 and the rods 176. While the telescoping mechanism 174 includes two rods 176 and two sliders 180 in the illustrated embodiment, in other embodiments, the telescoping mechanism may include more or fewer rods (e.g., 1, 3, 4, etc.) and a corresponding number of sliders.

The telescoping mechanism 174 enables the hopper 94 to move relative to the auxiliary storage compartment 54, thereby enabling the operator to position the hopper 94 at a suitable and/or convenient position for loading the particulate material into the filling assembly 56′. In the illustrated embodiment, the frame 178 of the telescoping mechanism 174 includes handles 182 configured to enable the operator to move the hopper 94 relative to the fill chute 90′/auxiliary storage compartment 54 using the telescoping mechanism 174. While the frame 178 includes two handles 182 in the illustrated embodiment, in other embodiments, the frame may include more or fewer handles (e.g., 0, 1, 3, 4, etc.). For example, in certain embodiments, the handles may be omitted. Furthermore, in the illustrated embodiment, the speed controller 106 is coupled to the frame 178, thereby enabling the speed controller 106 to move with the hopper 94. However, in other embodiments, the speed controller may be coupled to the support frame of the platform assembly, as disclosed above with reference to FIGS. 2-6.

In the illustrated embodiment, the fill tube 92 includes the flexible hose 124. The flexible hose 124 is configured to extend and retract as the distance between the hopper 94 and the fill chute 90′ is adjusted. In other embodiments, the fill tube may include multiple substantially rigid conduits (e.g., alone or in combination with the flexible hose). The substantially rigid conduits may be engaged with one another and configured to slide relative to one another, thereby enabling the fill tube to extend and retract. For example, one substantially rigid conduit may be coupled to the fill chute (e.g., via the connector and the latch), and another substantially rigid conduit may be coupled to the hopper. One substantially rigid conduit may be partially disposed within the other substantially rigid conduit, thereby enabling the fill tube to extend and retract via telescoping of the substantially rigid conduits.

In certain embodiments, the telescoping mechanism 174 includes a locking mechanism configured to maintain the distance between the hopper 94 and the fill chute 90′. For example, the locking mechanism may include a protrusion coupled to a slider 180 and configured to selectively engage one of a series of apertures or recesses along a respective rod 176. Furthermore, the locking mechanism may include a set screw engaged with a slider 180 and configured to selectively apply pressure to a respective rod 176. The operator may disengage the locking mechanism to adjust the distance between the hopper 94 and the fill chute 90′, and the operator may engage the locking mechanism to maintain the selected distance between the hopper 94 and the fill chute 90′.

The telescoping mechanism 174 is configured to facilitate extension and retraction of the fill tube 92 while the fill tube 92 is coupled to the fill chute 90′ (e.g., to the second portion 168 of the fill chute 90′). For example, with the door 134 in the open position, the fill tube 92 may be engaged with the fill chute 90′, and the latch 130 may be engaged with the connector 122, thereby coupling the fill tube 92 to the fill chute 90′. The operator may adjust the distance between the hopper 94 and the fill chute 90′ via the telescoping mechanism 174, which causes the fill tube 92 to extend/retract. In addition, the filling assembly 56′ may be transitioned to the operation state by disengaging the latch 130 from the connector 122, disengaging the fill tube 92 from the fill chute 90′, transitioning the door 134 to the closed position, and engaging the latch 130 with the door 134. In certain embodiments, with the fill tube 92 disengaged from the fill chute 90′, the locking mechanism may be disengaged, and the hopper 94 may be attached to the support frame 114 of the platform assembly 58. As a result, the fill tube 92, the hopper 94, the lid 96, and the fill tray 100 may not interfere with the weight monitoring of the auxiliary storage compartment. Accordingly, the accuracy of a determined weight of the particulate material within the auxiliary storage compartment (e.g., determined by subtracting the weight of the auxiliary storage compartment structure) may be enhanced.

While the telescoping mechanism 174 includes the rods 176 and the sliders 180 in the illustrated embodiment, in other embodiments, the telescoping mechanism may include other suitable components configured to facilitate extension and retraction of the fill tube to adjust the distance between the hopper and the fill chute. For example, in certain embodiments, the telescoping mechanism may include a track assembly, telescoping rods, or other suitable components. Furthermore, while the auxiliary storage compartment assembly 52″ includes the fill chute 90′ with the pivot joint 170 and the telescoping mechanism 174 in the illustrated embodiment, in other embodiments, the auxiliary storage compartment assembly may only include one of the telescoping mechanism or the fill chute with the pivot joint.

While the fill chute 90′ includes the pivot joint 170, the filling assembly 56′ includes the telescoping mechanism 174, and the hopper 94 is not coupled to the frame support 114 of the platform assembly 58, the remaining elements of the auxiliary storage compartment assembly 52″ may be the same as the auxiliary storage compartment assembly disclosed above with reference to FIGS. 2-6 and/or the auxiliary storage compartment assembly disclosed above with reference to FIG. 7 (e.g., in which like characters represent like elements). Accordingly, any of the details and variations disclosed above with regard to the auxiliary storage compartment assembly of FIGS. 2-6 and/or with regard to the auxiliary storage compartment assembly of FIG. 7 may apply to the illustrated auxiliary storage compartment assembly 52″, except with regard to the structure of the fill chute and the mounting of the hopper.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. An auxiliary storage compartment assembly for an air cart, comprising:
an auxiliary storage compartment configured to be positioned beneath a portion of a primary storage compartment of the air cart, wherein the auxiliary storage compartment includes an opening in a lateral side of the auxiliary storage compartment;
a filling assembly coupled to the auxiliary storage compartment, wherein the filling assembly comprises a fill chute engaged with the lateral side of the auxiliary storage compartment, the filling assembly has an inlet and an outlet, the outlet is formed at the fill chute, the outlet is aligned with the opening of the auxiliary storage compartment, and the filling assembly establishes a flow path that extends downwardly and laterally inwardly from the inlet to the outlet; and
a conveyor assembly comprising a rotary conveyor and a motor assembly, wherein the rotary conveyor extends through a portion of the filling assembly and through a portion of the auxiliary storage compartment, the motor assembly is configured to drive the rotary conveyor in rotation, and the rotary conveyor is configured to move particulate material laterally through the portion of the filling assembly and through the portion of the auxiliary storage compartment in response to rotation of the rotary conveyor;
wherein the motor assembly is coupled to the fill chute, the motor assembly is disposed within the auxiliary storage compartment, or a combination thereof.

2. The auxiliary storage compartment assembly of claim 1, wherein the filling assembly comprises a fill tube and a hopper, the fill chute is coupled to the lateral side of the auxiliary storage compartment, the inlet of the filling assembly is formed at the hopper, and the fill tube is positioned between the hopper and the fill chute.

3. The auxiliary storage compartment assembly of claim 2, wherein the fill tube comprises a flexible hose.

4. The auxiliary storage compartment assembly of claim 2, wherein the fill tube is removably coupled to the fill chute by a latch.

5. The auxiliary storage compartment assembly of claim 4, wherein the fill tube engages the fill chute at an inlet of the fill chute, the filling assembly comprises a door configured to move between an open position and a closed position to selectively block the inlet of the fill chute while the fill tube is not engaged with the fill chute, and the latch is configured to secure the door in the closed position.

6. The auxiliary storage compartment assembly of claim 1, wherein the filling assembly comprises a lid configured to selectively block the inlet of the filling assembly.

7. The auxiliary storage compartment assembly of claim 1, wherein the rotary conveyor comprises an open coil coupled to a central shaft.

8. The auxiliary storage compartment assembly of claim 1, wherein the motor assembly is coupled to the fill chute, and the motor assembly extends through an opening in the fill chute, such that a portion of the motor assembly is disposed within an interior of the fill chute.

9. An auxiliary storage compartment assembly for an air cart, comprising:
a filling assembly configured to couple to an auxiliary storage compartment of the air cart, wherein the filling assembly comprises a fill chute, a fill tube, and a hopper, the fill tube is positioned between the hopper and the fill chute, the fill chute is configured to engage a lateral side of the auxiliary storage compartment, the auxiliary storage compartment is configured to be positioned beneath a portion of a primary storage compartment of the air cart, the filling assembly has an inlet and an outlet, the inlet is formed at the hopper, the outlet is formed at the fill chute, the outlet is configured to align with an opening in a lateral side of the auxiliary storage compartment, and the filling assembly is configured to establish a flow path that extends downwardly and laterally inwardly from the inlet to the outlet; and
a conveyor assembly comprising a rotary conveyor, wherein the rotary conveyor extends through a portion of the filling assembly and is configured to extend through a portion of the auxiliary storage compartment, and the rotary conveyor is configured to move particulate material laterally through the portion of the filling assembly and through the portion of the auxiliary storage compartment in response to rotation of the rotary conveyor;
wherein the fill tube is removably coupled to the fill chute, the fill tube engages the fill chute at an inlet of the fill chute, and the filling assembly comprises a door configured to move between an open position and a closed position to selectively block the inlet of the fill chute while the fill tube is not engaged with the fill chute.

10. The auxiliary storage compartment assembly of claim 9, comprising a latch configured to couple the fill tube to the fill chute, wherein the latch is configured to secure the door in the closed position.

11. The auxiliary storage compartment assembly of claim 9, wherein the filling assembly is configured to orient the flow path at an angle of about 35 degrees relative to a lateral axis of the auxiliary storage compartment assembly.

12. The auxiliary storage compartment assembly of claim 9, wherein the rotary conveyor comprises an open coil coupled to a central shaft.

13. The auxiliary storage compartment assembly of claim 9, wherein the conveyor assembly comprises a motor assembly configured to drive the rotary conveyor in rotation; and
wherein the motor assembly is coupled to the fill chute, the motor assembly is configured to be disposed within the auxiliary storage compartment, or a combination thereof.

14. The auxiliary storage compartment assembly of claim 9, comprising a platform assembly configured to be positioned adjacent to the auxiliary storage compartment, wherein the platform assembly comprises a platform configured to support an operator.

15. The auxiliary storage compartment assembly of claim 14, wherein the filling assembly comprises a retainer configured to secure the fill tube to a support frame of the platform assembly while the fill tube is not engaged with the fill chute.

16. An auxiliary storage compartment assembly for an air cart, comprising:
a filling assembly configured to couple to an auxiliary storage compartment of the air cart, wherein the filling assembly comprises a fill chute, a fill tube, and a hopper, the fill tube is positioned between the hopper and the fill chute, the fill chute is configured to engage a lateral side of the auxiliary storage compartment, the auxiliary storage compartment is configured to be positioned beneath a portion of a primary storage compartment of the air cart, the filling assembly has an inlet and an outlet, the inlet is formed at the hopper, the outlet is formed at the fill chute, the outlet is configured to align with an opening in the lateral side of the auxiliary storage compartment, and the filling assembly is configured to establish a flow path that extends downwardly and laterally inwardly from the inlet to the outlet; and
a conveyor assembly comprising a rotary conveyor, wherein the rotary conveyor extends through a portion of the filling assembly and is configured to extend through a portion of the auxiliary storage compartment, and the rotary conveyor is configured to move particulate material laterally through the portion of the filling assembly and through the portion of the auxiliary storage compartment in response to rotation of the rotary conveyor;
wherein the fill chute has a first portion configured to engage the lateral side of the auxiliary storage compartment, the fill chute has a second portion configured to engage the fill tube, the fill chute comprises a pivot joint pivotally coupling the first portion and the second portion to one another to enable the fill tube and the hopper to move relative to the auxiliary storage compartment, and the pivot joint is configured to facilitate passage of the particulate material through the fill chute;
wherein the filling assembly comprises a telescoping mechanism configured to facilitate extension and retraction of the fill tube to adjust a distance between the hopper and the fill chute; or
a combination thereof.

17. The auxiliary storage compartment assembly of claim 16, wherein the fill tube is removably coupled to the fill chute, the fill tube engages the fill chute at an inlet of the fill chute, and the filling assembly comprises a door configured to move between an open position and a closed position to selectively block the inlet of the fill chute while the fill tube is not engaged with the fill chute.

18. The auxiliary storage compartment assembly of claim 17, comprising a latch configured to couple the fill tube to the fill chute, wherein the latch is configured to secure the door in the closed position.

19. The auxiliary storage compartment assembly of claim 16, wherein the fill tube comprises a flexible hose.

20. The auxiliary storage compartment assembly of claim 16, wherein the conveyor assembly comprises a motor assembly configured to drive the rotary conveyor in rotation; and
wherein the motor assembly is coupled to the fill chute, the motor assembly is configured to be disposed within the auxiliary storage compartment, or a combination thereof.
